(19) United States
(12) Patent Application Publication
(10) Pub. No.: US 2025/0310807 A1
(43) Pub. Date: Oct. 2, 2025

(54) CHANNEL STATE INFORMATION CONFIGURATION

(71) Applicant: QUALCOMM Incorporated, San Diego, CA (US)

(72) Inventors: Jing DAI, Beijing (CN); Liangming WU, Beijing (CN); Lei XIAO, San Jose, CA (US); Wei XI, Beijing (CN); Min HUANG, Beijing (CN); Hao XU, Beijing (CN)

(21) Appl. No.: 18/864,141

(22) PCT Filed: Jul. 22, 2022
(86) PCT No.: PCT/CN2022/107320

§ 371 Date: Nov. 8, 2024

(51) Int. Cl. H04W 24/10

(52) U.S. Cl. CPC H04W 24/10

(57) ABSTRACT

Various aspects of the present disclosure generally relate to wireless communication. In some aspects, a user equipment (UE) may receive a configuration for a channel state information (CSI) window having a size that is based at least in part on a time unit associated with the configuration. The UE may receive CSI reference signals (CSI-RSs). The UE may generate a CSI report based at least in part on measurements of one or more CSI-RSs that are within the CSI window. The UE may transmit the CSI report. Numerous other aspects are described.

### FIELD OF THE DISCLOSURE

Aspects of the present disclosure generally relate to wireless communication and to techniques and apparatuses for configuring channel state information reporting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration for a channel state information (CSI) window having a size that is based at least in part on a time unit associated with the configuration. The method may include receiving CSI reference signals (CSI-RSs). The method may include generating a CSI report based at least in part on measurements of one or more CSI-RSs that are within the CSI window. The method may include transmitting the CSI report.

Some aspects described herein relate to a method of wireless communication performed by a network entity. The method may include transmitting a configuration for a CSI window having a size that is based at least in part on a time unit associated with the configuration. The method may include transmitting CSI-RSs. The method may include receiving a CSI report.

Some aspects described herein relate to a method of wireless communication performed by a UE. The method may include determining that a CSI report is to be dropped if a CSI-RS is unavailable or not received. The method may include refraining from transmitting a CSI report if a CSI-RS is unavailable or not received.

Some aspects described herein relate to a UE for wireless communication. The UE may include a memory and one or more processors coupled to the memory. The one or more processors may be configured to receive a configuration for a CSI window having a size that is based at least in part on a time unit associated with the configuration. The one or more processors may be configured to receive CSI-RSs. The one or more processors may be configured to generate a CSI report based at least in part on measurements of one or more CSI-RSs that are within the CSI window. The one or more processors may be configured to transmit the CSI report.

Some aspects described herein relate to a network entity for wireless communication. The network entity may include a memory and one or more processors coupled to the memory. The one or more processors may be configured to transmit a configuration for a CSI window having a size that is based at least in part on a time unit associated with the configuration. The one or more processors may be configured to transmit CSI-RSs. The one or more processors may be configured to receive a CSI report.

Some aspects described herein relate to a UE for wireless communication. The UE may include a memory and one or more processors coupled to the memory. The one or more processors may be configured to determine that a CSI report is to be dropped if a CSI-RS is unavailable or not received. The one or more processors may be configured to refrain from transmitting a CSI report if a CSI-RS is unavailable or not received.

Some aspects described herein relate to a non-transitory computer-readable medium that stores a set of instructions for wireless communication by a UE. The set of instructions, when executed by one or more processors of the UE, may cause the UE to receive a configuration for a CSI window having a size that is based at least in part on a time unit associated with the configuration. The set of instructions, when executed by one or more processors of the UE, may cause the UE to receive CSI-RSs. The set of instructions, when executed by one or more processors of the UE, may cause the UE to generate a CSI report based at least in part on measurements of one or more CSI-RSs that are within the CSI window. The set of instructions, when executed by one or more processors of the UE, may cause the UE to transmit the CSI report.

Some aspects described herein relate to a non-transitory computer-readable medium that stores a set of instructions for wireless communication by a network entity. The set of instructions, when executed by one or more processors of the network entity, may cause the network entity to transmit a configuration for a CSI window having a size that is based at least in part on a time unit associated with the configuration. The set of instructions, when executed by one or more processors of the network entity, may cause the network entity to transmit CSI-RSs. The set of instructions, when executed by one or more processors of the network entity, may cause the network entity to receive a CSI report.

Some aspects described herein relate to a non-transitory computer-readable medium that stores a set of instructions for wireless communication by a UE. The set of instructions, when executed by one or more processors of the UE, may cause the UE to determine that a CSI report is to be dropped if a CSI-RS is unavailable or not received. The set of instructions, when executed by one or more processors of the UE, may cause the UE to refrain from transmitting a CSI report if a CSI-RS is unavailable or not received.

Some aspects described herein relate to an apparatus for wireless communication. The apparatus may include means for receiving a configuration for a CSI window having a size that is based at least in part on a time unit associated with the configuration. The apparatus may include means for receiving CSI-RSs. The apparatus may include means for generating a CSI report based at least in part on measurements of one or more CSI-RSs that are within the CSI window. The apparatus may include means for transmitting the CSI report.

Some aspects described herein relate to an apparatus for wireless communication. The apparatus may include means for transmitting a configuration for a CSI window having a size that is based at least in part on a time unit associated with the configuration. The apparatus may include means for transmitting CSI-RSs. The apparatus may include means for receiving a CSI report.

Some aspects described herein relate to an apparatus for wireless communication. The apparatus may include means for determining that a CSI report is to be dropped if a CSI-RS is unavailable or not received. The apparatus may include means for refraining from transmitting a CSI report if a CSI-RS is unavailable or not received.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity (e.g., base station) in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating examples of channel state information (CSI) reference signal (CSI-RS) beam management procedures, in accordance with the present disclosure.

FIG. 5 is a diagram illustrating an example of a precoding matrix for fast-varying beams, in accordance with the present disclosure.

FIG. 6 is a diagram illustrating an example of time domain parameters, in accordance with the present disclosure.

FIG. 7 is a diagram illustrating an example associated with CSI time locations, in accordance with the present disclosure.

FIG. 8 is a diagram illustrating an example of a CSI window having a size that is based on a time unit, in accordance with the present disclosure.

FIG. 9 is a diagram illustrating an example associated with using a CSI window with a size that is based on a time unit, in accordance with the present disclosure.

FIG. 10 is a diagram illustrating an example of a CSI window location, in accordance with the present disclosure.

FIG. 11 is a diagram illustrating an example associated with missing CSI reports, in accordance with the present disclosure.

FIG. 12 is a diagram illustrating an example process performed, for example, by a UE, in accordance with the present disclosure.

FIG. 13 is a diagram illustrating an example process performed, for example, by a network entity, in accordance with the present disclosure.

FIG. 14 is a diagram illustrating an example process performed, for example, by a UE, in accordance with the present disclosure.

FIGS. 15-16 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

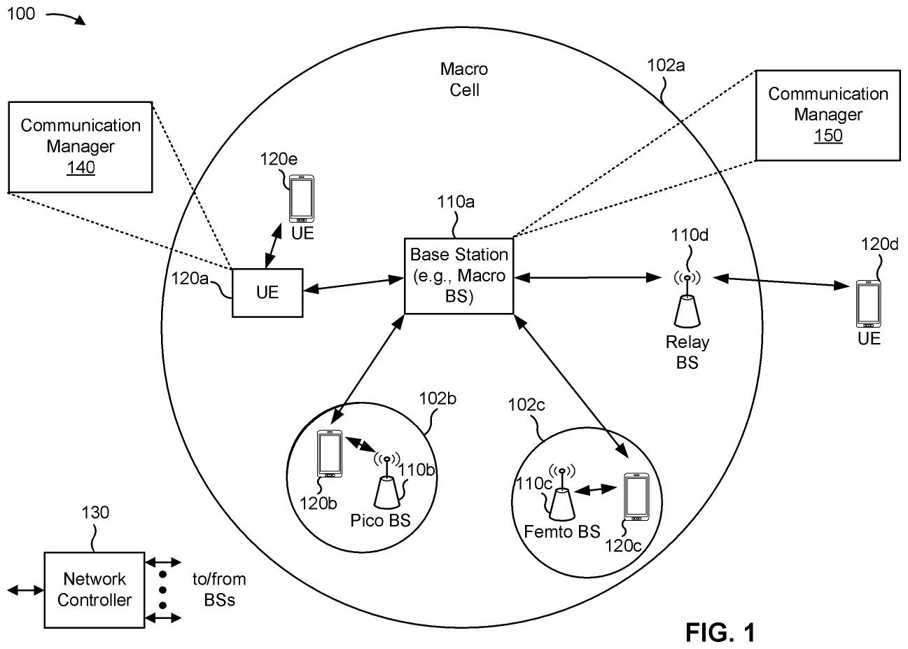

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmit receive point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration for a channel state information (CSI) window having a size that is based at least in part on a time unit associated with the configuration. The communication manager 140 may receive CSI reference signals (CSI-RSs). The communication manager 140 may generate a CSI report based at least in part on measurements of one or more CSI-RSs that are within the CSI window and transmit the CSI report.

In some aspects, the communication manager 140 may determine that a CSI report is to be dropped if a CSI-RS is unavailable or not received. The communication manager 140 may refrain from transmitting a CSI report if a CSI-RS is unavailable or not received. Additionally, or alternatively, the communication manager 140 may perform one or more other operations described herein.

In some aspects, a network entity (e.g., base station 110) may include a communication manager 150. As described in more detail elsewhere herein, the communication manager 150 may transmit a configuration for a CSI window having a size that is based at least in part on a time unit associated with the configuration; transmit CSI-RSs. The communication manager 150 may receive a CSI report. Additionally, or alternatively, the communication manager 150 may perform one or more other operations described herein.

As indicated above, FIG. 1 is provided as an example. Other examples may differ from what is described with regard to FIG. 1.

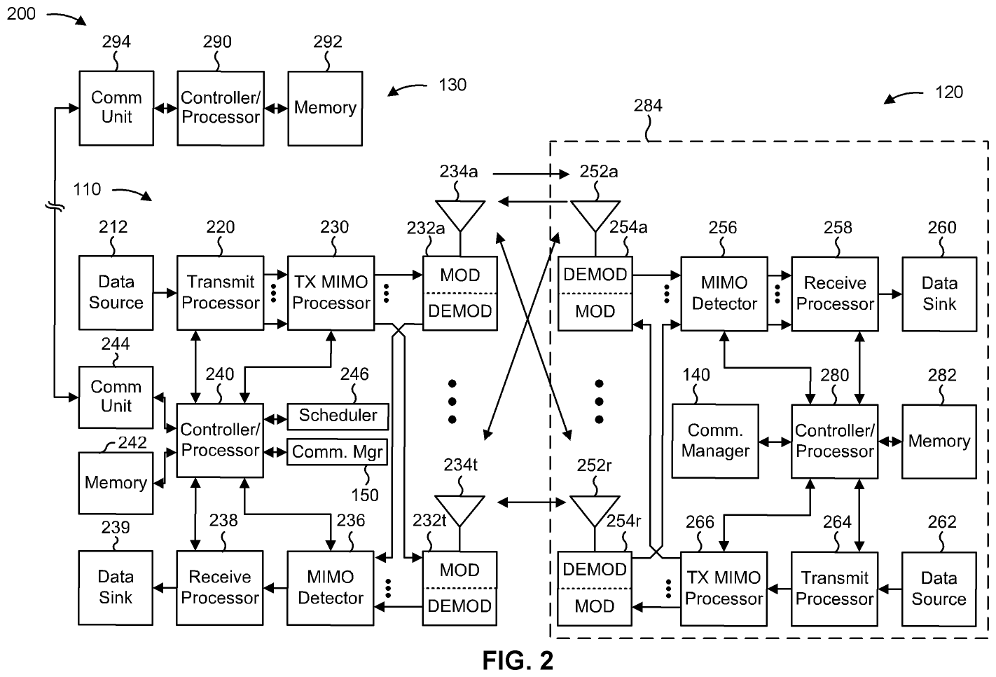

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

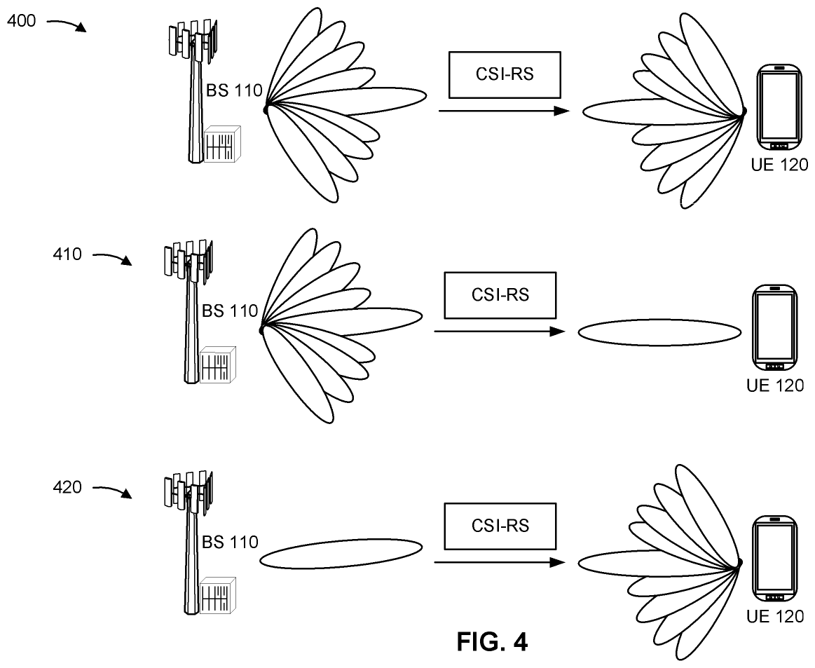

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-16).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-16).

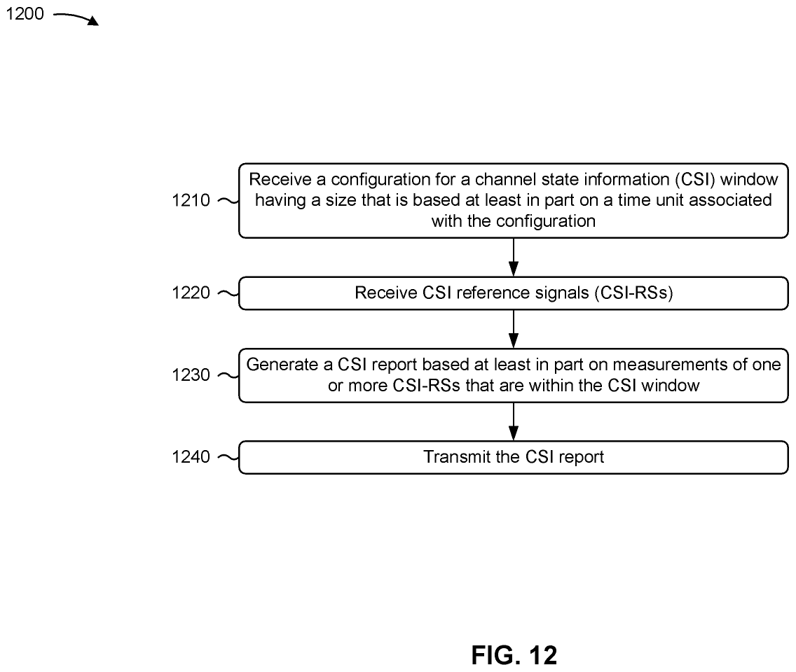

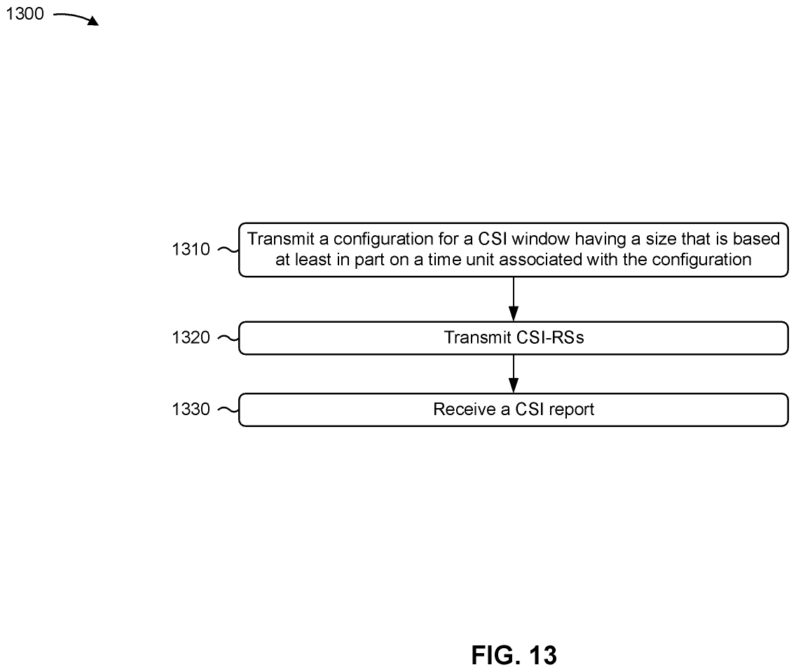

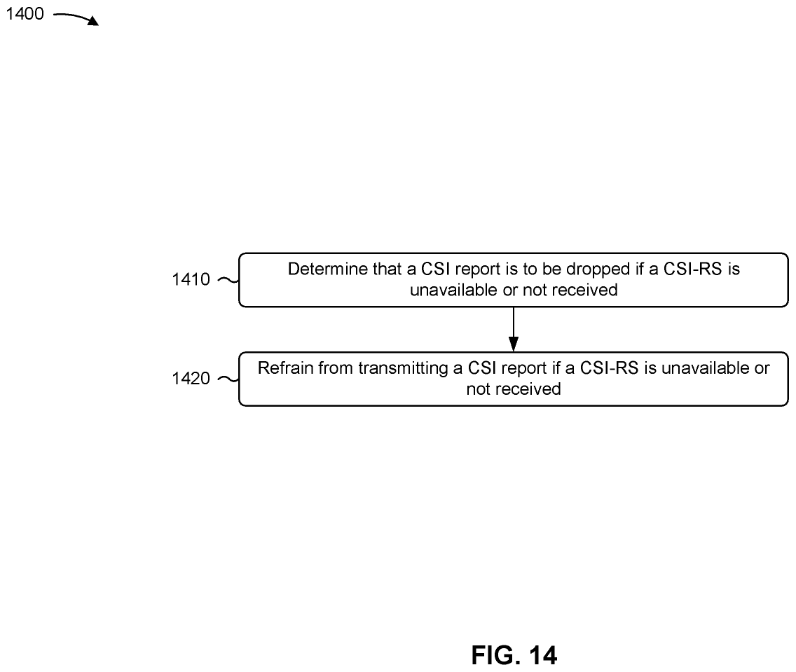

A controller/processor of a network entity (e.g., the controller/processor 240 of the base station 110), the controller/processor 280 of the UE 120, and/or any other component(s) of FIG. 2 may perform one or more techniques associated with configuring a CSI window size based on a time unit, as described in more detail elsewhere herein. For example, the controller/processor 240 of the base station 110, the controller/processor 280 of the UE 120, and/or any other component(s) of FIG. 2 may perform or direct operations of, for example, process 1200 of FIG. 12, process 1300 of FIG. 13, process 1400 of FIG. 14, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 1200 of FIG. 12, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, the UE 120 includes means for receiving a configuration for a CSI window having a size that is based at least in part on a time unit associated with the configuration; means for receiving CSI-RSs; means for generating a CSI report based at least in part on measurements of one or more CSI-RSs that are within the CSI window; and/or means for transmitting the CSI report. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., base station 110) includes means for transmitting a configuration for a CSI window having a size that is based at least in part on a time unit associated with the configuration; means for transmitting CSI-RSs; and/or means for receiving a CSI report. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the UE 120 includes means for determining that a CSI report is to be dropped if a CSI-RS is unavailable or not received; and/or means for refraining from transmitting a CSI report if a CSI-RS is unavailable or not received.

As indicated above, FIG. 2 is provided as an example. Other examples may differ from what is described with regard to FIG. 2.

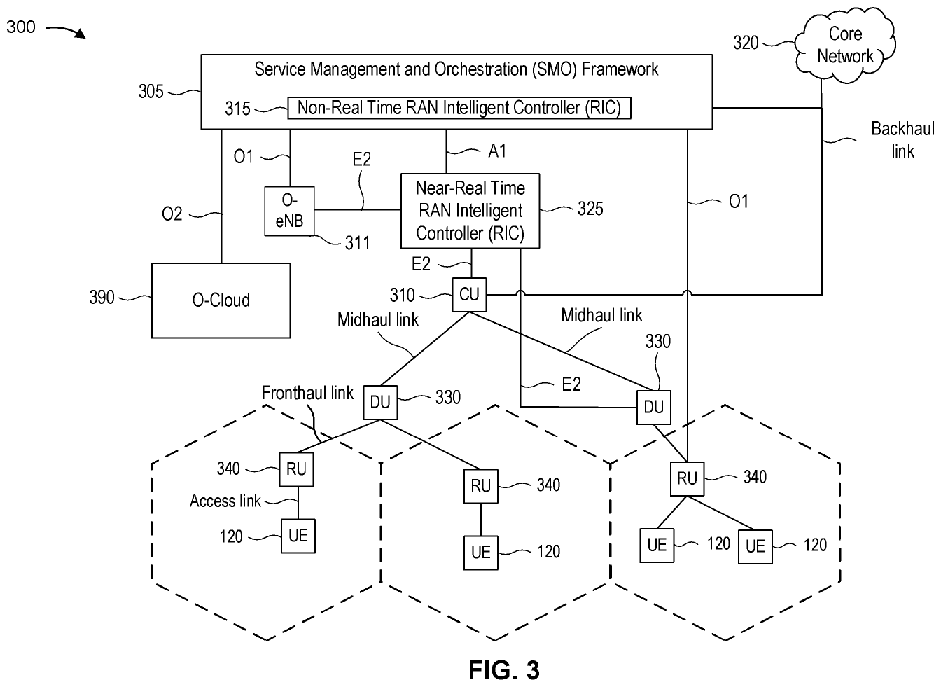

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point, a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUs (O-DUs”) and “O-RAN RUS (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as Al policies).

As indicated above, FIG. 3 is provided as an example. Other examples may differ from what is described with regard to FIG. 3.

FIG. 4 is a diagram illustrating examples 400, 410, and 420 of CSI-RS beam management procedures, in accordance with the present disclosure. As shown in FIG. 4, examples 400, 410, and 420 include a UE 120 in communication with a network entity (e.g., base station 110) in a wireless network (e.g., wireless network 100). However, the devices shown in FIG. 4 are provided as examples, and the wireless network may support communication and beam management between other devices (e.g., between a UE 120 and a base station 110 or TRP, between a mobile termination node and a control node, between an IAB child node and an IAB parent node, and/or between a scheduled node and a scheduling node). In some aspects, the UE 120 and the base station 110 may be in a connected state (e.g., an RRC connected state).

As shown in FIG. 4, example 400 may include a base station 110 and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the base station 110 to the UE 120. The CSI-RSs may be configured to be periodic (e.g., using RRC signaling), semi-persistent (e.g., using MAC control element (MAC CE) signaling), and/or aperiodic (e.g., using DCI).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same CSI-RS resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UE 120 receive beam(s) beam pair(s). The UE 120 may report the measurements to the base station 110 to enable the base station 110 to select one or more beam pair(s) for communication between the base station 110 and the UE 120. While example 400 has been described in connection with CSI-RSs, the first beam management process may also use synchronization signal blocks (SSBs) for beam management in a similar manner as described above.

As shown in FIG. 4, example 410 may include a base station 110 and a UE 120 communicating to perform beam management using CSI-RSs. Example 410 depicts a second beam management procedure (e.g., P2 CSI-RS beam management). The second beam management procedure may be referred to as a beam refinement procedure, a base station beam refinement procedure, a TRP beam refinement procedure, and/or a transmit beam refinement procedure. As shown in FIG. 4 and example 410, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same CSI-RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams).

As indicated above, FIG. 4 is provided as an example of beam management procedures. Other examples of beam management procedures may differ from what is described with respect to FIG. 4. For example, the UE 120 and the base station 110 may perform the third beam management procedure before performing the second beam management procedure, and/or the UE 120 and the base station 110 may perform a similar beam management procedure to select a UE transmit beam.

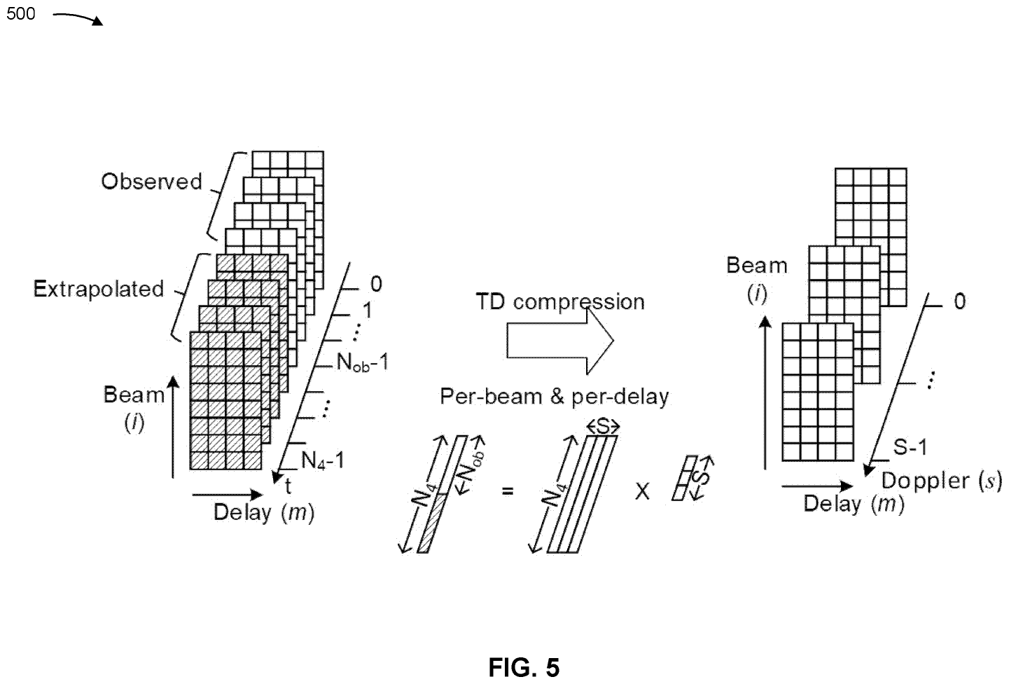

FIG. 5 is a diagram illustrating an example 500 of a precoding matrix for fast-varying beams, in accordance with the present disclosure.

The UE 120 may measure CSI-RSs and transmit a CSI report that indicates CSI, such as a precoding matrix indicator (PMI). A PMI is a matrix that represents how data is transformed to antenna ports. The CSI report may include a codebook, which is a set of precoders or one or more PMIs. A Type-I codebook may include predefined matrices. A Type-II codebook may include a more detailed CSI report for multi-user MIMO and may include a group of beams. An enhanced Type-II codebook (eType-II codebook) may be eType-II codebook structure can be generalized as W=W₁×\tilde{W}₂×W_{f}^{H} . A CSI report may include a precoder W₂, which is a coefficient matrix that indicates how to associate precoding weights to the spatial domain (SD) basis and frequency domain (FD) basis vectors. Precoder W₂ is for Type-II codebooks and \tilde{W}₂ is for eType-II codebooks. For a medium or high velocity of a UE using a channel, the UE may use a time-domain codebook to represent the fast-varying (over time instance n) precoding matrix: W(n)=W₁×\tilde{W}₂(n)×W_{f}^{H}. W₁ represents selected SD bases, W_{f} represents selected FD bases, and W_{f}^{H} represents all FD bases. Example 500 shows compression of the coefficient matrix \tilde{W}₂(n), n=0, . . . , N₄−1 into the Doppler domain (DD) via FFT of the time domain (TD). SD basis W₁ and FD basis W_{f} are expected to be constant over time. The length of a DD or TD basis vector may be represented by N₄. N_{ob} may represent a length of CSI-RS observations in the TD. There may also be a quantity of extrapolations (predicted observations) in the TD.

There may be at least two approaches to CSI reporting. In a first approach, the UE is reporting with only CSI-RS observations (N_{ob}=N₄)—compression at the UE, with prediction at the network entity. In a second approach, the UE is reporting with both observations and extrapolations (N_{ob}<N₄)—both compression and prediction at the UE.

As indicated above, FIG. 5 is provided as an example. Other examples may differ from what is described with regard to FIG. 5.

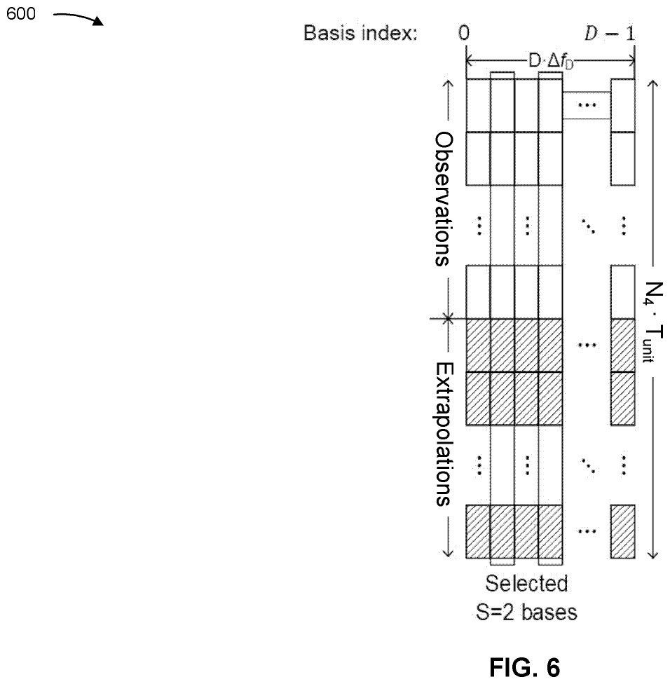

FIG. 6 is a diagram illustrating an example 600 of TD parameters, in accordance with the present disclosure.

Example 600 shows multiple time units (Tᵤₙᵢₜ), where the length of a DD/TD basis vector may be N₄. Example 600 shows that for frequencies up to a FD basis D, in the TD there may a quantity of observations and a quantity of extrapolations. Two SD bases (S=2 bases) are selected in example 600.

With respect to Type-II codebook refinement for high or medium velocities, for codebook structures with a DD or TD basis, the codebook(s) may include additional codebook parameters. Such codebook parameters may include a DD/TD basis vector length and parameters for DD/TD basis vector selection. The codebook parameters may also include a quantity of DD/TD basis vectors and, if applicable, basis selection indicators. If applicable, a codebook parameter may include the total quantity of available DD/TD basis vectors, whether explicitly or implied from another parameter (e.g., oversampling factor). For the Type-II codebook refinement for high or medium velocities, there may be an implicit or explicit basis type indicator and/or a DD/TD (compression) unit.

As indicated above, FIG. 6 is provided as an example. Other examples may differ from what is described with regard to FIG. 6.

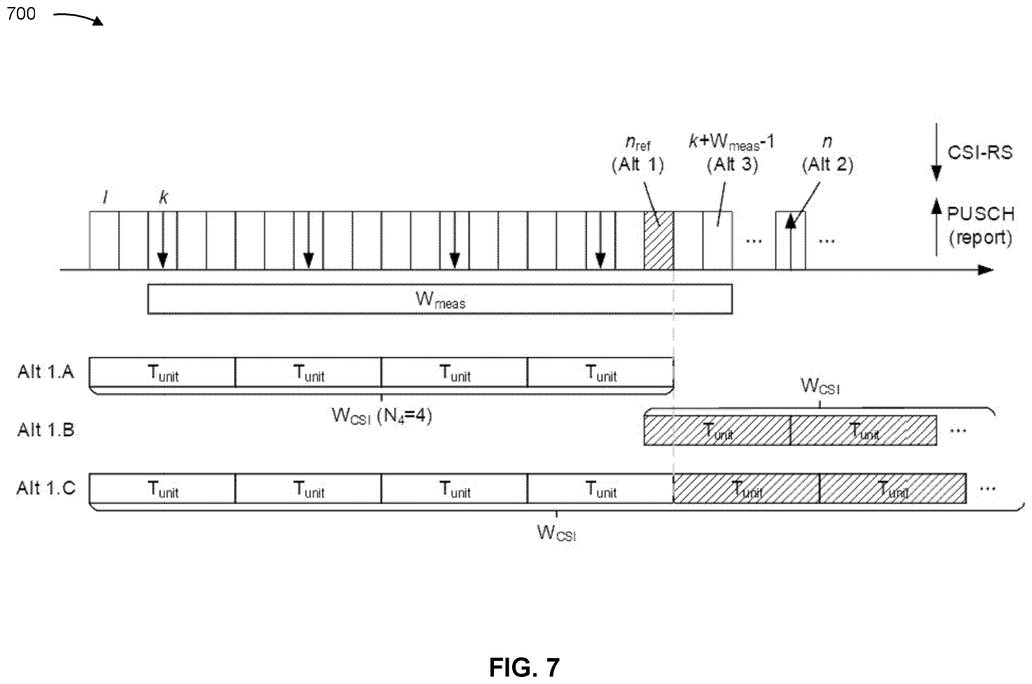

FIG. 7 is a diagram illustrating an example 700 associated with CSI time locations, in accordance with the present disclosure.

As mentioned above, the UE may perform CSI reporting for Type-II codebook for high or medium velocities. Example 700 shows multiple time units (Tᵤₙᵢₜ) in a CSI window, noted as W_{CSI}. Wₘₑₐₛ is the window length (in slots) of a measurement window, which may reside within the CSI window. The UE may transmit a CSI report in slot n, and the length of the DD/TD basis vector may be N₄. In example 700, the length is 4 time units. Note that the basis vector may have no span/window in the time-domain, only length.

The window locations may be defined by starting slot l or k. A measurement window of [k, k+Wₘₑₐₛ−1] may represent the window in which CSI-RS occasions are measured for calculating a CSI report, where k is a slot index, and CSI-RS occasions are configured in CSI-ReportConfig. A CSI window of [l, l+W_{CSI}−1] may be associated with the CSI report in slot n, l may be a slot index, and W_{CSI} may be the CSI window length (in slots). The location of a CSI reference resource in the time domain may be denoted as n_{ref} (slot index).

There may be multiple alternatives for CSI reporting with Type-II codebook refinement for high or medium velocities. First alternatives for potential down-selection of a CSI time location with n_{ref} (CSI reference resource slot) as a boundary may include Alt1.A: l+W_{CSI}−1≤n_{ref}; Alt1.B: l≥n_{ref}; or Alt1.C: l<n_{ref} and l+W_{CSI}−1>n_{ref}. Second alternatives with n (the CSI report slot) as a boundary may include Alt2.A: l+W_{CSI}−1≤n; Alt2.B:/≥n; or Alt2.C: l<n and l+W_{CSI}−1>n. Third alternatives with an end slot of Wₘₑₐₛ (k+Wₘₑₐₛ−1) as a boundary may include Alt3.A: l+W_{CSI}−1≤k+Wₘₑₐₛ−1 with the following as a special case: l=k, W_{CSI}=Wₘₑₐₛ; Alt3.B: l≥k+Wₘₑₐₛ−1; or Alt3.C: l<k+Wₘₑₐₛ−1 and/+W_{CSI}−1>k+Wₘₑₐₛ−1 with the following as special cases: l=k, l+W_{CSI}=n or l=k, l+W_{CSI}>n. Note that Alt 1, 2, and 3 differentiate which slot is used as a boundary of past (observation) and future (prediction). Alt {1.A, 2.A, 3.A} are observation-only, Alt {1.B, 2.B, 3.B} are prediction-only, and Alt {1.C, 2.C, 3.C} are observation and prediction.

There may be two issues that relate to a burst of CSI-RS occasions. A first issue is that, for a burst of CSI-RS occasions for TD CSI measurement, it has not been specified how the CSI window [l,l+W_{CSI}−1] or the measurement window [k, k+Wₘₑₐₛ−1] are to be defined.

A second issue is that one or more CSI-RS occasions within the burst can be unavailable or not received due to an uplink slot conflict (e.g., in a time division duplexing (TDD) system), a bandwidth part (BWP) switch, a serving cell activation, an RRC (re) configuration (CSI-related), an activation of a semi-persistent report, or a configuration of discontinuous reception (DRX). UE behavior has not been specified for when one or more CSI-RS occasions are missed. Without specifying UE behavior for these two issues, CSI inaccuracies may degrade communications, which causes processing resources and signaling resources to be wasted.

As indicated above, FIG. 7 is provided as an example. Other examples may differ from what is described with regard to FIG. 7.

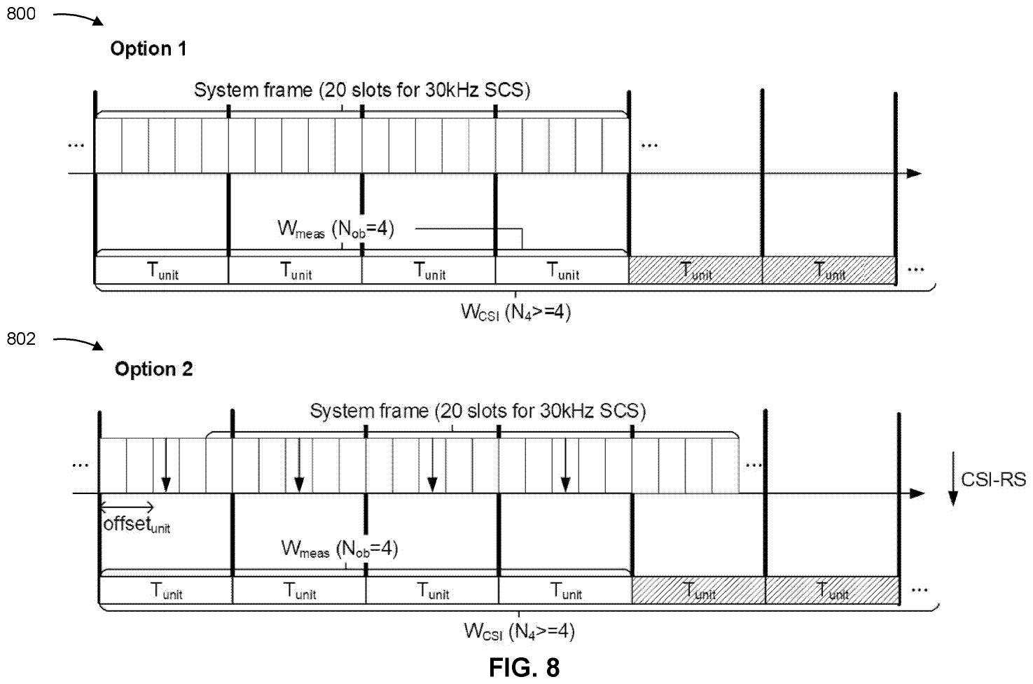

FIG. 8 is a diagram illustrating an example 800 of a CSI window having a size that is based on a time unit, in accordance with the present disclosure.

According to various aspects described herein, a CSI window may have a size that is based at least in part on a time unit. For a time-domain CSI report, a CSI window may be defined as a number (N₄/N_{ob}) of time units (respectively denoted as W_{CSI}=N₄Tᵤₙᵢₜ and Wₘₑₐₛ=N_{ob}Tᵤₙᵢₜ), where Tᵤₙᵢₜ may be integer multiples (e.g., 1, 2, 3) of the time interval between two consecutive CSI-RS occasions. There may be the same quantity of CSI-RS occasions per time unit. For the case of Tᵤₙᵢₜ equaling the time interval, Tᵤₙᵢₜ may have a periodicity for periodic (P) CSI-RS or for semi-persistent (SP) CSI-RS. In some aspects, the Tᵤₙᵢₜ may be equal to a time interval between two consecutive CSI-RS occasions within a CSI-RS burst. By defining the CSI window size in relation to Tᵤₙᵢₜ, CSI accuracy may improve. As a result, communications may improve and resources may be conserved.

The time may be split into units. In some aspects, as a first option shown by example 800, there may be an absolute split based at least in part on system frame numbers. The split may be aligned according to system frame #0. For example, the starting slot of a time unit may be defined as slot n_{unitStart} satisfying (Nₛₗₒₜ^{frame,μ}n_{f}+nᵤₙᵢₜₛₜₐᵣₜ^{μ})mod Tᵤₙᵢₜ=0 for n_{unitStart}^{μ}∈{0,1, . . . , Nₛₗₒₜ^{frame,μ}−1}, where the system frame number (SFN) n_{f}∈{0,1, . . . , 1023}. For numerology parameter μ=0 (15 kHz subcarrier spacing (SCS)), Nₛₗₒₜ^{frame,μ} may be 10; for μ=1 (30 kHz SCS), Nₛₗₒₜ^{frame,μ} may be 20; for μ=2 (60 KHz SCS), Nₛₗₒₜ^{frame,μ} may be 40; for μ=3 (120 kHz SCS), Nₛₗₒₜ^{frame,μ} may be 80; for and μ=4 (240 kHz SCS), Nₛₗₒₜ^{frame,μ} may be 160

In some aspects, as a second option shown by example 802, there may be a split according to the CSI-RS, with a predefined or preconfigured offsetᵤₙᵢₜ to the slot where CSI-RS occasions are located. For example, a predefined (by standard) offsetᵤₙᵢₜ=0 or Tᵤₙᵢₜ/2 or [Tᵤₙᵢₜ/2] or [Tᵤₙᵢ/2], or a preconfigured (by network entity) offsetᵤₙᵢₜ∈{0,1, . . . , Tᵤₙᵢₜ−1}.

As indicated above, FIG. 8 is provided as an example. Other examples may differ from what is described with regard to FIG. 8.

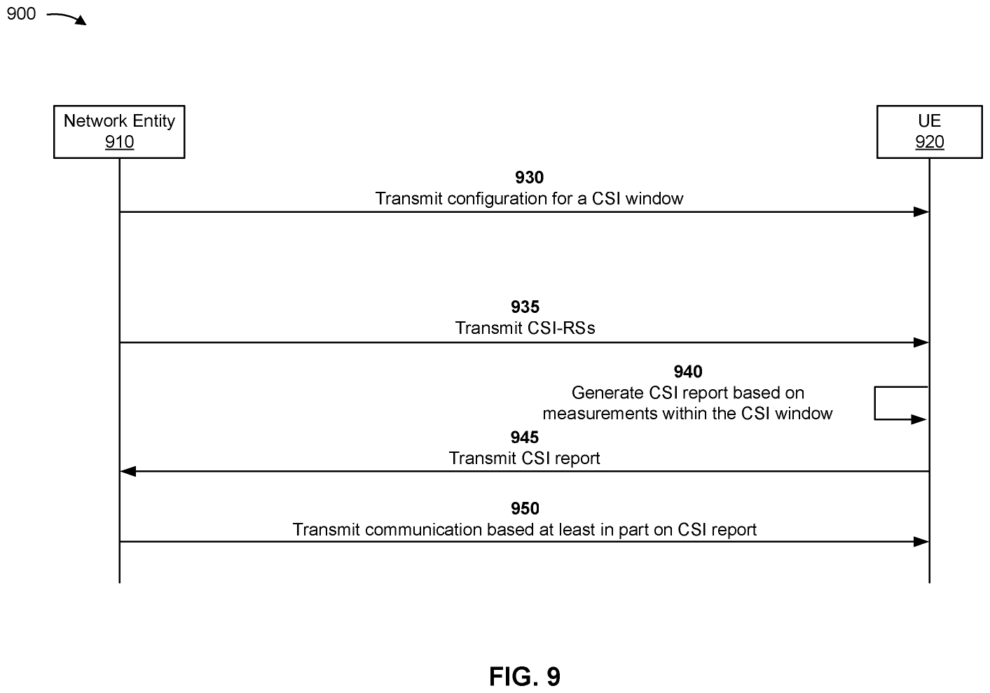

FIG. 9 is a diagram illustrating an example 900 associated with using a CSI window with a size that is based on a time unit, in accordance with the present disclosure. As shown in FIG. 9, a network entity 910 (e.g., base station 110) and a UE 920 (e.g., a UE 120) may communicate with one another on a wireless network (e.g., wireless network 100).

The UE 920 may use coherent joint transmission (CJT) with multiple TRPs. CJT involves multiple transmitters that each transmit a message with a phase that is constructively combined at a receiver. CJT may include beamforming with antennas that are not co-located and that correspond to different TRPs. CJT may improve the signal power and spatial diversity of communications in an NR network.

As shown by reference number 930, the network entity 910 may transmit a configuration for a CSI window having a size that is based at least in part on a time unit (Tᵤₙᵢₜ) associated with the configuration. That is, the size of the CSI window is configured in consideration of Tᵤₙᵢₜ, which may be predefined for the UE 920. The configuration may indicate the time unit and/or the size of the CSI window based on Tᵤₙᵢₜ. The CSI window (time units 0 to N_{ob}−1) may include a measurement window. The size of the measurement window may not be predefined (by a standard), and the value of Tᵤₙᵢₜ may not be explicitly configured by the network entity 910. The value of Tᵤₙᵢₜ may be implicitly configured as W_{CSI}/N₄ or as the time interval (or one or more integer multiples of the time interval) between consecutive CSI-RS occasions. The value of Tᵤₙᵢₜ may correspond to a periodicity (e.g., one CSI-RS occasion per time unit) or to one or integer multiples of a periodicity. The periodicity may include a CSI-RS periodicity or may be for an aperiodic (AP) CSI-RS burst.

As shown by reference number 935, the network entity 910 may transmit CSI-RSs. As shown by reference number 940, the UE 920 may generate a CSI report based at least in part on measurements of the CSI-RSs that are within the CSI window. As shown by reference number 945, the UE 920 may transmit the CSI report. As shown by reference number 950, the network entity 910 may transmit a communication based at least in part on the CSI report. By basing a size of the CSI window on a specified or indicated time unit, the UE may perform CSI measurements and report more accurate CSI for a fast moving UE. Improved CSI accuracy improves communications and conserves processing resources and signaling resources.

As indicated above, FIG. 9 is provided as an example. Other examples may differ from what is described with regard to FIG. 9.

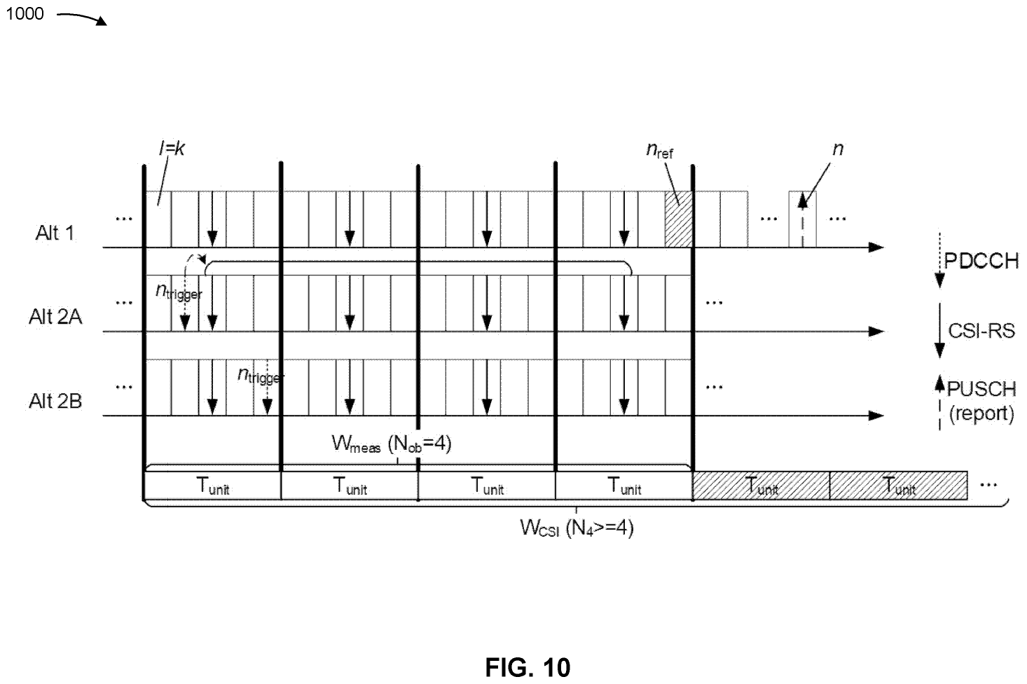

FIG. 10 is a diagram illustrating an example 1000 of a CSI window location, in accordance with the present disclosure.

In some aspects, the configuration from the network entity 1210 may indicate a starting slot for the CSI window. The starting slot may be based at least in part on an offset relative to a CSI reference resource slot or a reporting slot. For example, as shown by example 1000 for the starting slot of CSI window (l or k), the starting slot may be relative to a CSI reference resource slot (n_{ref}) or a report (physical uplink shared channel (PUSCH)) slot (n). The first time unit for the CSI window may be the time unit that includes the latest CSI-RS occasion that is no later than slot n_{ref} as the N_{ob}-th time unit of the CSI window.

In some aspects, the starting slot may be based at least in part on an offset relative to a triggering slot, such a triggering PDCCH slot n_{trigger}. In some aspects, for either AP-CSI-RS or P-CSI-RS, the first time unit of the CSI window may be the time unit that includes the first CSI-RS occasion no earlier than slot n_{trigger}. In some aspects, the first time unit of the CSI window for P-CSI-RS may be the time unit that includes slot n_{trigger}. The first CSI-RS occasion may be earlier than slot n_{trigger}. The CSI and measurement window may be aligned with a starting slot (e.g., l=k).

As indicated above, FIG. 10 is provided as an example. Other examples may differ from what is described with regard to FIG. 10.

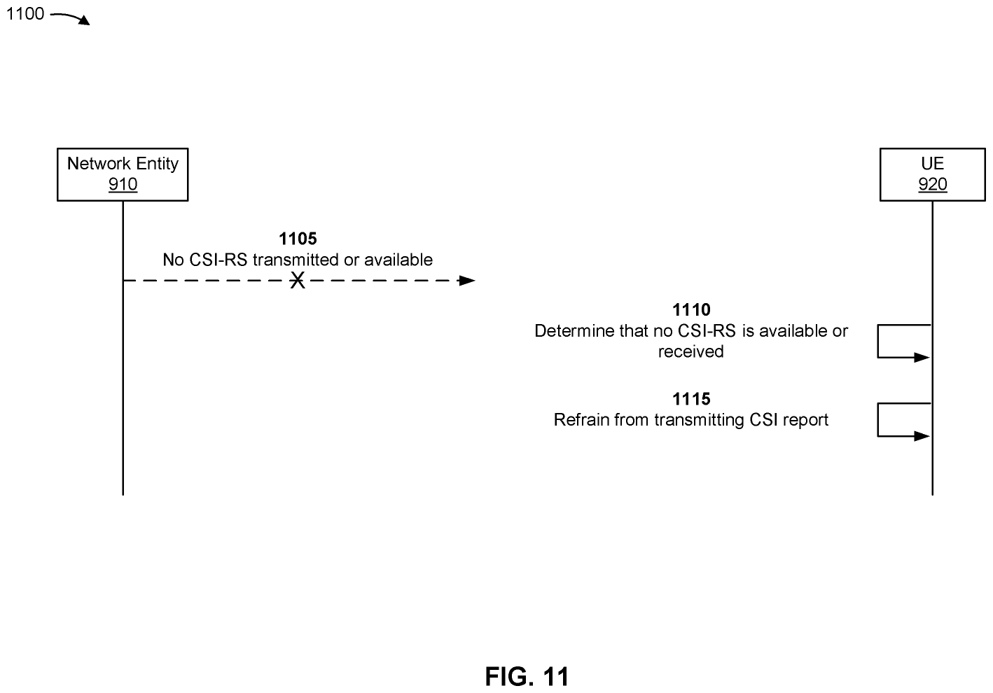

FIG. 11 is a diagram illustrating an example 1100 associated with missing CSI reports, in accordance with the present disclosure.

In some aspects, the UE 1220 may not expect CSI-RSs associated with the CSI window to be unavailable (e.g., UE 1220 may only allow AP-CSI-RS bursts for TD CSI). However, if no CSI-RS is transmitted, as shown by reference number 1105, the UE 1220 may determine that no CSI-RS is received or available, as shown by reference number 1110. As shown by reference number 1115, the UE 1220 may refrain from transmitting a CSI report. The UE 1220 may refrain from transmitting the CSI report after a BWP change, a serving cell activation, a CSI report (re)configuration, an activation of SP-CSI, or a DRX configuration.

In some aspects, the UE 1220 may transmit a TD CSI report only after receiving a threshold quantity of CSI-RS occasions (e.g., ≥N_{ob} CSI-RS occasions) no later than CSI reference resource (before or at slot n_{ref}) and may drop the CSI report otherwise. When DRX is configured, the UE 1220 may transmit a TD CSI report only after receiving ≥N_{ob} CSI-RS occasions no later than CSI reference resource (slot n_{ref}) at DRX active time or DRXonDuration and may drop the CSI report otherwise.

In some aspects, the UE 1220 may involve higher complexity implementation algorithms. For the configured size-N_{ob} measurement window, the UE 1220 may expect at least N_{ob}−X available CSI-RS occasions, where X>0 (e.g., X=1). X may be set based at least in part on a reported UE capability. When one or more CSI-RS occasions (of the configured N_{ob}) are unavailable, the same TD basis may be used. That is, the TD basis length N₄ may not change. Interpolation may be needed for the projection onto the TD. For the non-transmitted CSI-RS occasion(s), no measured channel at these instances (time units) is available. An algorithm may use other (neighbor) measured instances (time units) to obtain an interpolated channel at these non-measured instances. Alternatively, the TD basis length may be reduced to N₄−X. As a result, the UE 1220 may be able to reduce a complexity of CSI window sizing and conserve processing resources.

As indicated above, FIG. 11 is provided as an example. Other examples may differ from what is described with regard to FIG. 11.

FIG. 12 is a diagram illustrating an example process 1200 performed, for example, by a UE, in accordance with the present disclosure. Example process 1200 is an example where the UE (e.g., UE 120, UE 1220) performs operations associated with configuring a CSI window based on a time unit.

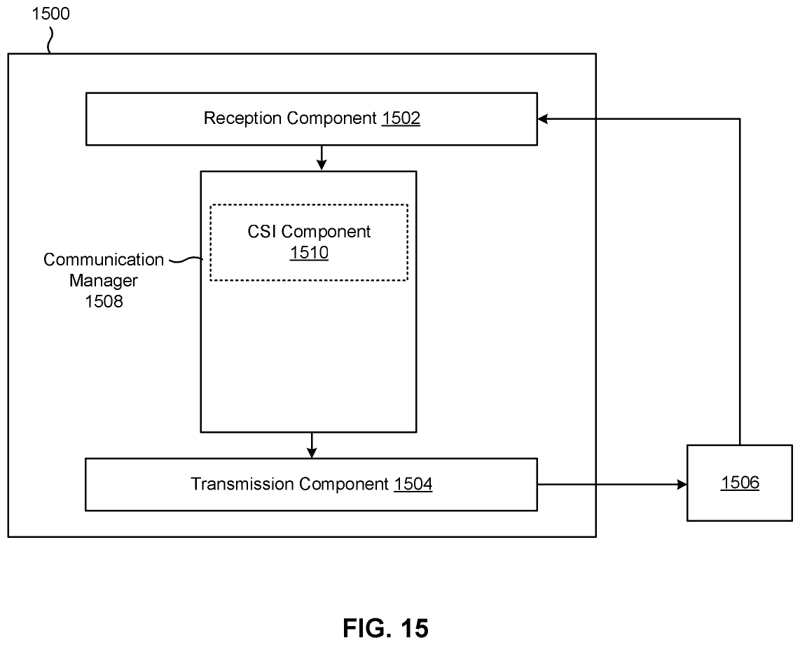

As shown in FIG. 12, in some aspects, process 1200 may include receiving a configuration for a CSI window having a size that is based at least in part on a time unit associated with the configuration (block 1210). For example, the UE (e.g., using communication manager 1508 and/or reception component 1502 depicted in FIG. 15) may receive a configuration for a CSI window having a size that is based at least in part on a time unit associated with the configuration, as described above.

As further shown in FIG. 12, in some aspects, process 1200 may include receiving CSI-RSs (block 1220). For example, the UE (e.g., using communication manager 1508 and/or reception component 1502 depicted in FIG. 15) may receive CSI-RSs, as described above.

As further shown in FIG. 12, in some aspects, process 1200 may include generating a CSI report based at least in part on measurements of one or more CSI-RSs that are within the CSI window (block 1230). For example, the UE (e.g., using communication manager 1508 and/or CSI component 1510 depicted in FIG. 15) may generate a CSI report based at least in part on measurements of one or more CSI-RSs that are within the CSI window, as described above.

As further shown in FIG. 12, in some aspects, process 1200 may include transmitting the CSI report (block 1240). For example, the UE (e.g., using communication manager 1508 and/or transmission component 1504 depicted in FIG. 15) may transmit the CSI report, as described above.

Process 1200 may include additional aspects, such as any single aspect or any combination of aspects described below and/or in connection with one or more other processes described elsewhere herein.

In a first aspect, the time unit corresponds to one or integer multiples of a CSI-RS periodicity.

In a second aspect, alone or in combination with the first aspect, the time unit corresponds to one or integer multiples of a time interval between consecutive CSI-RS occasions.

In a third aspect, alone or in combination with one or more of the first and second aspects, the time unit is based at least in part on SFNs.

In a fourth aspect, alone or in combination with one or more of the first through third aspects, the time unit is based at least in part on an offset relative to a CSI-RS occasion location.

In a fifth aspect, alone or in combination with one or more of the first through fourth aspects, the configuration indicates a starting slot for the CSI window.

In a sixth aspect, alone or in combination with one or more of the first through fifth aspects, the starting slot is based at least in part on an SFN.

In a seventh aspect, alone or in combination with one or more of the first through sixth aspects, the starting slot is based at least in part on an offset relative to a CSI reference resource slot or a reporting slot.

In an eighth aspect, alone or in combination with one or more of the first through seventh aspects, the starting slot is based at least in part on an offset relative to a triggering slot.

In a ninth aspect, alone or in combination with one or more of the first through eighth aspects, a first time unit of the CSI window is a time unit that includes a first SI-RS occasion that is no earlier than a triggering slot.

In a tenth aspect, alone or in combination with one or more of the first through ninth aspects, a first time unit of the CSI window is a time unit that includes a triggering slot.

In an eleventh aspect, alone or in combination with one or more of the first through tenth aspects, the configuration indicates the size of the CSI window.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network entity, in accordance with the present disclosure. Example process 1300 is an example where the network entity (e.g., base station 110, network entity 1210) performs operations associated with configuring a CSI window based on a time unit.

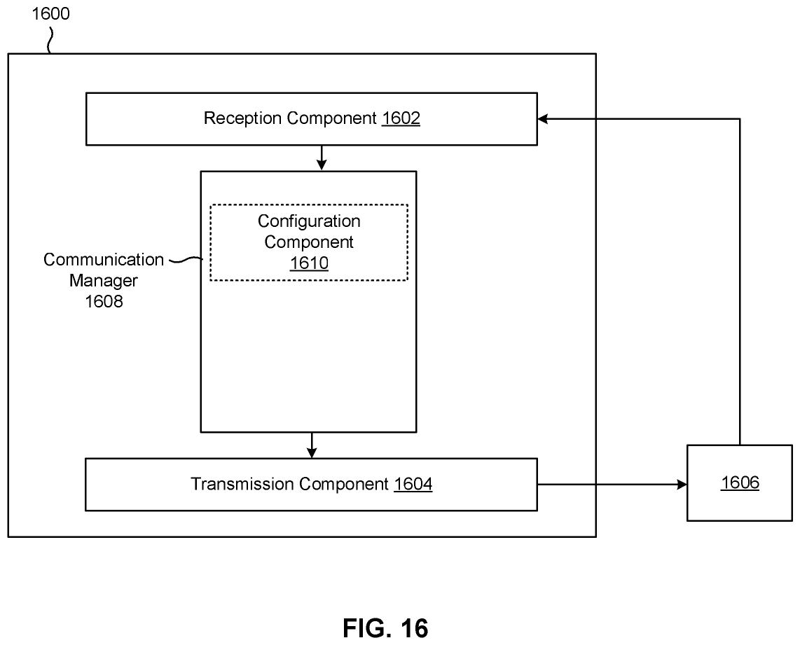

As shown in FIG. 13, in some aspects, process 1300 may include transmitting a configuration for a CSI window having a size that is based at least in part on a time unit associated with the configuration (block 1310). For example, the network entity (e.g., using communication manager 1608 and/or transmission component 1604 depicted in FIG. 16) may transmit a configuration for a CSI window having a size that is based at least in part on a time unit associated with the configuration, as described above.

As further shown in FIG. 13, in some aspects, process 1300 may include transmitting CSI-RSs (block 1320). For example, the network entity (e.g., using communication manager 1608 and/or transmission component 1604 depicted in FIG. 16) may transmit CSI-RSs, as described above.

As further shown in FIG. 13, in some aspects, process 1300 may include receiving a CSI report (block 1330). For example, the network entity (e.g., using communication manager 1608 and/or reception component 1602 depicted in FIG. 16) may receive a CSI report, as described above.

Process 1300 may include additional aspects, such as any single aspect or any combination of aspects described below and/or in connection with one or more other processes described elsewhere herein.

In a first aspect, the time unit corresponds to one or integer multiples of a CSI-RS periodicity.

In a second aspect, alone or in combination with the first aspect, the time unit corresponds to one or integer multiples of a time interval between consecutive CSI-RS occasions.

In a third aspect, alone or in combination with one or more of the first and second aspects, the time unit is based at least in part on SFNs.

In a fourth aspect, alone or in combination with one or more of the first through third aspects, the time unit is based at least in part on an offset relative to a CSI-RS occasion location.

In a fifth aspect, alone or in combination with one or more of the first through fourth aspects, the configuration indicates a starting slot for the CSI window.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a UE, in accordance with the present disclosure. Example process 1400 is an example where the UE (e.g., UE 120, UE 1220) performs operations associated with CSI reporting.

As shown in FIG. 14, in some aspects, process 1400 may include determining that a CSI report is to be dropped if a CSI-RS is unavailable or not received (block 1410). For example, the UE (e.g., using communication manager 1508 and/or CSI component 1510 depicted in FIG. 15) may determine that a CSI report is to be dropped if a CSI-RS is unavailable or not received, as described above.

As further shown in FIG. 14, in some aspects, process 1400 may include refraining from transmitting a CSI report if a CSI-RS is unavailable or not received (block 1420). For example, the UE (e.g., using communication manager 1508 and/or CSI component 1510 depicted in FIG. 15) may refrain from transmitting a CSI report if a CSI-RS is unavailable or not received, as described above.

Process 1400 may include additional aspects, such as any single aspect or any combination of aspects described below and/or in connection with one or more other processes described elsewhere herein.

In a first aspect, refraining from transmitting the CSI report includes refraining from transmitting the CSI report if the CSI-RS are unavailable or not received at a threshold quantity of CSI-RS occasions no later than a CSI reference resource.

In a second aspect, alone or in combination with the first aspect, refraining from transmitting the CSI report includes refraining from transmitting the CSI report after a BWP change or a serving cell activation.

In a third aspect, alone or in combination with one or more of the first and second aspects, refraining from transmitting the CSI report includes refraining from transmitting the CSI report after an uplink slot conflict.

In a fourth aspect, alone or in combination with one or more of the first through third aspects, refraining from transmitting the CSI report includes refraining from transmitting the CSI report after receiving a CSI report reconfiguration or a DRX configuration.

In a fifth aspect, alone or in combination with one or more of the first through fourth aspects, refraining from transmitting the CSI report includes refraining from transmitting the CSI report after an activation of semi-persistent CSI.

In a sixth aspect, alone or in combination with one or more of the first through fifth aspects, refraining from transmitting the CSI report includes refraining from transmitting the CSI report after a specified quantity of CSI-RS occasions.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE (e.g., UE 120, UE 1220), or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 1508. The communication manager 1508 may control and/or otherwise manage one or more operations of the reception component 1502 and/or the transmission component 1504. In some aspects, the communication manager 1508 may include one or more antennas, a modem, a controller/processor, a memory, or a combination thereof, of the UE described in connection with FIG. 2. The communication manager 1508 may be, or be similar to, the communication manager 140 depicted in FIGS. 1 and 2. For example, in some aspects, the communication manager 1508 may be configured to perform one or more of the functions described as being performed by the communication manager 140. In some aspects, the communication manager 1508 may include the reception component 1502 and/or the transmission component 1504. The communication manager 1508 may include a CSI component 1510, among other examples.

In some aspects, the apparatus 1500 may be configured to perform one or more operations described herein in connection with FIGS. 1-11. Additionally, or alternatively, the apparatus 1500 may be configured to perform one or more processes described herein, such as process 1200 of FIG. 12, process 1400 of FIG. 14, or a combination thereof. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

In some aspects, the reception component 1502 may receive a configuration for a CSI window having a size that is based at least in part on a time unit associated with the configuration. The reception component 1502 may receive CSI-RSs. The CSI component 1510 may generate a CSI report based at least in part on measurements of one or more CSI-RSs that are within the CSI window. The transmission component 1504 may transmit the CSI report.

In some aspects, the CSI component 1510 may determine that a CSI report is to be dropped if a CSI-RS is unavailable or not received. The CSI component 1510 may refrain from transmitting a CSI report if a CSI-RS is unavailable or not received.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a network entity (e.g., base station 110, network entity 1210), or a network entity may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 1608. The communication manager 1608 may control and/or otherwise manage one or more operations of the reception component 1602 and/or the transmission component 1604. In some aspects, the communication manager 1608 may include one or more antennas, a modem, a controller/processor, a memory, or a combination thereof, of the network entity described in connection with FIG. 2. The communication manager 1608 may be, or be similar to, the communication manager 150 depicted in FIGS. 1 and 2. For example, in some aspects, the communication manager 1608 may be configured to perform one or more of the functions described as being performed by the communication manager 150. In some aspects, the communication manager 1608 may include the reception component 1602 and/or the transmission component 1604. The communication manager 1608 may include a configuration component 1610, among other examples.

In some aspects, the apparatus 1600 may be configured to perform one or more operations described herein in connection with FIGS. 1-11. Additionally, or alternatively, the apparatus 1600 may be configured to perform one or more processes described herein, such as process 1300 of FIG. 13. In some aspects, the apparatus 1600 and/or one or more components shown in FIG. 16 may include one or more components of the network entity described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network entity described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the network entity described in connection with FIG. 2. In some aspects, the transmission component 1604 may be co-located with the reception component 1602 in a transceiver.

The transmission component 1604 may transmit a configuration for a CSI window having a size that is based at least in part on a time unit associated with the configuration. The configuration component 1610 may generate the configuration based at least in part on a UE capability, traffic conditions, and/or channel conditions. The transmission component 1604 may transmit CSI-RSs. The reception component 1602 may receive a CSI report.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:
Aspect 1: A method of wireless communication performed by a user equipment (UE), comprising: receiving a configuration for a channel state information (CSI) window having a size that is based at least in part on a time unit associated with the configuration; receiving CSI reference signals (CSI-RSs); generating a CSI report based at least in part on measurements of one or more CSI-RSs that are within the CSI window; and transmitting the CSI report.
Aspect 2: The method of Aspect 1, wherein the time unit corresponds to one or integer multiples of a CSI-RS periodicity.
Aspect 3: The method of Aspect 1, wherein the time unit corresponds to one or integer multiples of a time interval between consecutive CSI-RS occasions.
Aspect 4: The method of any of Aspects 1-3, wherein the time unit is based at least in part on system frame numbers.
Aspect 5: The method of Aspects 1-4, wherein the time unit is based at least in part on an offset relative to a CSI-RS occasion location.
Aspect 6: The method of Aspects 1-5, wherein the configuration indicates a starting slot for the CSI window.
Aspect 7: The method of Aspect 6, wherein the starting slot is based at least in part on a system frame number.
Aspect 8: The method of Aspect 6, wherein the starting slot is based at least in part on an offset relative to a CSI reference resource slot or a reporting slot.
Aspect 9: The method of Aspect 6, wherein the starting slot is based at least in part on an offset relative to a triggering slot.
Aspect 10: The method of Aspects 1-9, wherein a first time unit of the CSI window is a time unit that includes a first CSI-RS occasion that is no earlier than a triggering slot.
Aspect 11: The method of Aspects 1-9, wherein a first time unit of the CSI window is a time unit that includes a triggering slot.
Aspect 12: The method of Aspects 1-11, wherein the configuration indicates the size of the CSI window.
Aspect 13: A method of wireless communication performed by a network entity, comprising: transmitting a configuration for a channel state information (CSI) window having a size that is based at least in part on a time unit associated with the configuration; transmitting CSI reference signals (CSI-RSs); and receiving a CSI report.
Aspect 14: The method of Aspect 13, wherein the time unit corresponds to one or integer multiples of a CSI-RS periodicity.
Aspect 15: The method of Aspect 13, wherein the time unit corresponds to one or integer multiples of a time interval between consecutive CSI-RS occasions.
Aspect 16: The method of Aspect 13, wherein the time unit is based at least in part on system frame numbers.
Aspect 17: The method of Aspect 13, wherein the time unit is based at least in part on an offset relative to a CSI-RS occasion location.
Aspect 18: The method of any of Aspects 13-17, wherein the configuration indicates a starting slot for the CSI window.
Aspect 19: A method of wireless communication performed by a user equipment (UE), comprising: determining that a channel state information (CSI) report is to be dropped if a CSI reference signal (CSI-RS) is unavailable or not received; and refraining from transmitting a CSI report if a CSI-RS is unavailable or not received.
Aspect 20: The method of Aspect 19, wherein refraining from transmitting the CSI report includes refraining from transmitting the CSI report if the CSI-RS are unavailable or not received at a threshold quantity of CSI-RS occasions no later than a CSI reference resource.
Aspect 21: The method of Aspect 19 or 20, wherein refraining from transmitting the CSI report includes refraining from transmitting the CSI report after a bandwidth part change or a serving cell activation.
Aspect 22: The method of any of Aspects 19-21, wherein refraining from transmitting the CSI report includes refraining from transmitting the CSI report after an uplink slot conflict.
Aspect 23: The method of any of Aspects 19-22, wherein refraining from transmitting the CSI report includes refraining from transmitting the CSI report after receiving a CSI report reconfiguration or a discontinuous reception configuration.
Aspect 24: The method of any of Aspects 19-23, wherein refraining from transmitting the CSI report includes refraining from transmitting the CSI report after an activation of semi-persistent CSI.
Aspect 25: The method of any of Aspects 19-24, wherein refraining from transmitting the CSI report includes refraining from transmitting the CSI report after a specified quantity of CSI-RS occasions.
Aspect 26: An apparatus for wireless communication at a device, comprising a processor; memory coupled with the processor; and instructions stored in the memory and executable by the processor to cause the apparatus to perform the method of one or more of Aspects 1-25
Aspect 27: A device for wireless communication, comprising a memory and one or more processors coupled to the memory, the one or more processors configured to perform the method of one or more of Aspects 1-25.
Aspect 28: An apparatus for wireless communication, comprising at least one means for performing the method of one or more of Aspects 1-25.
Aspect 29: A non-transitory computer-readable medium storing code for wireless communication, the code comprising instructions executable by a processor to perform the method of one or more of Aspects 1-25.
Aspect 30: A non-transitory computer-readable medium storing a set of instructions for wireless communication, the set of instructions comprising one or more instructions that, when executed by one or more processors of a device, cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving a configuration for a channel state information (CSI) window having a size that is based at least in part on a time unit associated with the configuration;
receiving CSI reference signals (CSI-RSs);
generating a CSI report based at least in part on measurements of one or more CSI-RSs that are within the CSI window; and
transmitting the CSI report.

2. The method of claim 1, wherein the time unit corresponds to one or integer multiples of a CSI-RS periodicity.

3. The method of claim 1, wherein the time unit corresponds to one or integer multiples of a time interval between consecutive CSI-RS occasions.

4. The method of claim 1, wherein the time unit is based at least in part on system frame numbers.

5. The method of claim 1, wherein the time unit is based at least in part on an offset relative to a CSI-RS occasion location.

6. The method of claim 1, wherein the configuration indicates a starting slot for the CSI window.

7. The method of claim 6, wherein the starting slot is based at least in part on a system frame number.

8. The method of claim 6, wherein the starting slot is based at least in part on an offset relative to a CSI reference resource slot or a reporting slot.

9. The method of claim 6, wherein the starting slot is based at least in part on an offset relative to a triggering slot.

10. The method of claim 1, wherein a first time unit of the CSI window is a time unit that includes a first CSI-RS occasion that is no earlier than a triggering slot.

11. The method of claim 1, wherein a first time unit of the CSI window is a time unit that includes a triggering slot.

12. The method of claim 1, wherein the configuration indicates the size of the CSI window.

13. A method of wireless communication performed by a network entity, comprising:
transmitting a configuration for a channel state information (CSI) window having a size that is based at least in part on a time unit associated with the configuration;
transmitting CSI reference signals (CSI-RSs); and
receiving a CSI report.

14. The method of claim 13, wherein the time unit corresponds to one or integer multiples of a CSI-RS periodicity.

15. The method of claim 13, wherein the time unit corresponds to one or integer multiples of a time interval between consecutive CSI-RS occasions.

16. The method of claim 13, wherein the time unit is based at least in part on system frame numbers.

17. The method of claim 13, wherein the time unit is based at least in part on an offset relative to a CSI-RS occasion location.

18. The method of claim 13, wherein the configuration indicates a starting slot for the CSI window.

19. A method of wireless communication performed by a user equipment (UE), comprising:
determining that a channel state information (CSI) report is to be dropped if a CSI reference signal (CSI-RS) is unavailable or not received; and
refraining from transmitting a CSI report if a CSI-RS is unavailable or not received.

20. The method of claim 19, wherein refraining from transmitting the CSI report includes refraining from transmitting the CSI report if the CSI-RS are unavailable or not received at a threshold quantity of CSI-RS occasions no later than a CSI reference resource.

21. The method of claim 19, wherein refraining from transmitting the CSI report includes refraining from transmitting the CSI report after a bandwidth part change or a serving cell activation.

22. The method of claim 19, wherein refraining from transmitting the CSI report includes refraining from transmitting the CSI report after an uplink slot conflict.

23. The method of claim 19, wherein refraining from transmitting the CSI report includes refraining from transmitting the CSI report after receiving a CSI report reconfiguration or a discontinuous reception configuration.

24. The method of claim 19, wherein refraining from transmitting the CSI report includes refraining from transmitting the CSI report after an activation of semi-persistent CSI.

25. The method of claim 19, wherein refraining from transmitting the CSI report includes refraining from transmitting the CSI report after a specified quantity of CSI-RS occasions.

26. A user equipment (UE) for wireless communication, comprising:
a memory; and
one or more processors, coupled to the memory, configured to:
receive a configuration for a channel state information (CSI) window having a size that is based at least in part on a time unit associated with the configuration;
receive CSI reference signals (CSI-RSs);
generate a CSI report based at least in part on measurements of one or more CSI-RSs that are within the CSI window; and
transmit the CSI report.

27. The UE of claim 26, wherein the time unit corresponds to one or integer multiples of a CSI-RS periodicity.

28. The UE of claim 26, wherein the time unit corresponds to one or integer multiples of a time interval between consecutive CSI-RS occasions.

29. The UE of claim 26, wherein the time unit is based at least in part on system frame numbers.

30. The UE of claim 26, wherein the time unit is based at least in part on an offset relative to a CSI-RS occasion location.
